(19) United States
(12) Patent Application Publication
(10) Pub. No.: US 2020/0326195 A1
(43) Pub. Date: Oct. 15, 2020

(54) METHOD AND APPARATUS FOR COMPUTER-IMPLEMENTED TRAFFIC CONTROL OF MOTOR VEHICLES IN A PREDETERMINED AREA

(71) Applicant: Siemens Aktiengesellschaft, München (DE)

(72) Inventors: Stefan Gavranovic, Putzbrunn (DE); Sylvia Glas, München (DE); Veronika Heinrich, München (DE); Harald Held, Bockhorn (DE); Christine Zeller, München (DE)

(21) Appl. No.: 16/841,112

(22) Filed: Apr. 6, 2020

(30) Foreign Application Priority Data
Apr. 9, 2019 (EP) 19168146.9

(51) Int. Cl. G01C 21/34; G08G 1/07; G08G 1/015; G08G 1/01; G06N 3/08

(52) U.S. Cl. CPC G01C 21/3461; G08G 1/07; G06N 3/08; G08G 1/0125; G01C 21/3492; G08G 1/015

(57) ABSTRACT

Provided is a method and an apparatus for computer-implemented traffic control of motor vehicles in a predetermined area, in which, at predetermined intervals, respectively: values of traffic parameters are ascertained in the predetermined area by way of data capture, wherein at least some of the traffic parameters relate to the motor vehicles traveling in the predetermined area and the traffic parameters of a respective motor vehicle include its current position, direction of travel and speed; a set of optimized traffic control actions, which include the adjustment of variable traffic signaling devices, is determined by an optimization using a learned data-driven model and the optimized traffic control actions are carried out, wherein the optimization takes account of predicted air quality values and the data-driven model is learned by training data from a simulation.

### CROSS-REFERENCE TO RELATED APPLICATIONS

This application claims priority to EP Application No. 19168146.9, having a filing date of Apr. 9, 2019, the entire contents of which are hereby incorporated by reference.

### FIELD OF TECHNOLOGY

The following relates to a method and an apparatus for computer-implemented traffic control of motor vehicles in a predetermined area.

### BACKGROUND

The burden on the population on account of traffic-related emission of pollutants, such as nitric oxides and particulate matter, is an increasing problem, particularly in cities. Accordingly, there are ever more frequent driving bans in inner cities for motor vehicles and in particular, for certain vehicle types. However, such driving bans can lead to unwanted traffic problems on alternate routes. Further, the pollution load is increased on the alternate routes.

To reduce the emission of pollutants in metropolitan areas, there is the option of making increased use of zero-emission vehicles in the form of electric vehicles and of reducing the pollutant emission of motor vehicles, e.g., via the use of filters. However, these measures are only realizable long-term and require retrofitting of already licensed vehicles.

Dissertation “Integrated agent-based transport simulation and air pollution modelling in urban areas—the example of Munich”, May 6, 2014, TU Munich by Friederike Hülsmann (hereinafter referred to as document [1]) describes simulations that can be used to ascertain the air pollution in urban areas on the basis of agent-based traffic modeling. In the process, the effects of different scenarios, such as the behavior of road users or changes in vehicle technology, on the air quality can be analyzed. These simulations require much computational outlay and cannot be used within the scope of traffic control, by which the traffic in cities is adapted in real time by way of appropriate traffic control actions.

### SUMMARY

An aspect relates to develop a method and an apparatus for computer-implemented traffic control of motor vehicles in a predetermined area, which facilitate a traffic adjustment for obtaining improved air quality.

The method according to embodiments of the invention is used for computer-implemented traffic control of motor vehicles in a predetermined area. The steps explained below are respectively carried out at predetermined intervals, which need not be constant.

Initially, values of traffic parameters are ascertained in the predetermined area by way of data capture, wherein at least some of the traffic parameters relate to the motor vehicles traveling in the predetermined area and the traffic parameters of a respective motor vehicle comprise its current position, direction of travel and speed. The traffic parameters can be ascertained in different ways, with different variants of how these traffic parameters are ascertained being explained in more detail below.

In a next step, a set of optimized traffic control actions, which comprise the adjustment of variable traffic signaling devices, is determined by an optimization using a learned data-driven model. Then, these optimized traffic control actions are carried out.

The learned data-driven model is configured to ascertain (i.e., simulate) output quantities in the form of air quality values for a multiplicity of points in the predetermined area from input quantities in the form of values of the traffic parameters. Here, an air quality value reflects the air quality of the corresponding point. Depending on the definition, higher air quality values can represent better air quality or worse air quality. By way of example, the air quality values can be represented by pollutant concentrations, such as, e.g., nitric oxides and particulate matter.

The data-driven model used in the method according to embodiments of the invention is learned from a simulation by training data sets. Here, a respective training data set comprises values of the traffic parameters and associated air quality values that are determined by way of the simulation. A simulation known per se can be used as a simulation, for example the simulation described in the aforementioned document [1]. Since a corresponding simulation requires much computational outlay and is consequently not real-time capable, it is not used directly in the method according to embodiments of the invention for determining air quality values. Rather, training data sets are generated in advance by the simulation, a data-driven model then being learnt by said training data sets. Then, the learned data-driven model is real-time capable and can be used within the scope of traffic control.

The optimization used in the method according to embodiments of the invention comprises a prediction of air quality values, according to which values of the traffic parameters are respectively predicted proceeding from the values of the traffic parameters, ascertained by way of data capture, for different sets of traffic control actions, which comprise the adjustment of variable traffic signaling devices. Such a prediction is known per se and can be based, for example, on a transport model used to predict the movement of the motor vehicles and traffic parameters as a result thereof. In one configuration, one set of the different sets of traffic control actions may also comprise a set of so-called null actions, i.e., no traffic control actions are carried out in this case. For this set of traffic control actions, the predicted values of the traffic parameters correspond to the currently ascertained values of the traffic parameters.

Following the prediction of the values of the traffic parameters, predicted air quality values for the multiplicity of points in the predetermined area are ascertained from said predicted values by the learned data-driven model. Then, the set of optimized traffic control actions is determined by the optimization from the different sets of traffic control actions on the basis of a number of optimization goals, which comprise the goal of the highest possible overall air quality taking account of all predicted air quality values for the multiplicity of points and/or the goal of the highest possible partial air quality taking account of some of the predicted air quality values for some of the multiplicity of points. By way of example, the optimization goals can be represented by a cost function to be minimized or maximized. In the case of a plurality of optimization goals, the individual goals are taken into account by way of a weighted sum in the cost function. The weighting factors can be chosen differently depending on the priority of the individual optimization goals.

The method according to embodiments of the invention is distinguished in that traffic control that takes account of the air quality in a predetermined area is obtained for the first time. What is essential to embodiments of the invention here is that a learned data-driven model is used to this end, said data-driven model ensuring the real-time capability of the method, in contrast to the use of simulations.

Different data-driven models can be used, depending on the configuration of the method according to embodiments of the invention. The data-driven model is a neural network structure made of one or more neural networks. Nevertheless, the data-driven model may also be based on support vector machines, where applicable.

In addition to the aforementioned optimization goals, the number of optimization goals may also, where applicable, comprise the goal of the lowest possible variation of the predicted air quality values over the predetermined area. By way of example, this goal can be represented by the variance in the frequency distribution of the predicted air quality values. The smaller the variance, the lower the variation in the predicted air quality values.

In a particularly preferred embodiment, the traffic parameters further contain the vehicle model of the respective motor vehicles and/or air quality measurements at a number of measurement points in the predetermined area. In this way, the prediction of the air quality values is improved.

In a further variant of the method according to embodiments of the invention, the aforementioned data capture comprises the capture of the position and/or the speed and/or the direction of travel and/or the license plate of the respective motor vehicles using a multiplicity of cameras. The vehicle model of a respective motor vehicle can be determined by comparing the license plate with a database, in which the vehicle models for licensed motor vehicles are stored.

In a further embodiment of the method according to embodiments of the invention, the data capture is configured in such a way that at least some of the traffic parameters are wirelessly transmitted by the motor vehicles and received by a multiplicity of receivers in the predetermined area. As a result of this, the traffic parameters are ascertained in a particularly simple fashion.

The variable traffic signaling devices can have different configurations. The variable traffic signaling devices comprise traffic lights and/or road signs with a variable information content.

In a further, particularly preferred embodiment, the optimized traffic control actions comprise actions that influence the local public transport system, in particular a change in the frequency of one or more lines of the local public transport system (e.g., train and/or bus lines) and/or a change in the capacity of transportation or transport means (e.g., buses and/or trains) in the local public transport system. This increases the options for influencing the traffic.

In a further preferred configuration, the optimized traffic control actions comprise diversion instructions, which are transmitted to at least some of the motor vehicles and which adapt the route of the navigation system in the corresponding motor vehicle. This provides a further option for influencing the traffic.

In a further configuration, the optimized traffic control actions cause one or more road sections in the predetermined area to be shut for at least some of the motor vehicles and, in particular, for motor vehicles with a certain type of engine, e.g., diesel vehicles. In this way, legal provisions in view of a ban on vehicles can also be taken into account by the traffic control according to embodiments of the invention.

In a further variant of the method according to embodiments of the invention, the aforementioned simulation, which is carried out in advance for generating training data, is continued on the basis of traffic parameters that are ascertained using the data capture during the method according to embodiments of the invention, as a result of which new training data sets are obtained, by which the learning of the data-driven model is continued during the method according to embodiments of the invention. In this way, the traffic control is continuously improved by online learning of the data-driven model.

In addition to the above-described method, embodiments of the invention relate to an apparatus for computer-implemented traffic control of motor vehicles in a predetermined area, wherein the apparatus is configured to carry out the method according to embodiments of the invention or one or more preferred variants of the method according to embodiments of the invention.

Moreover, embodiments of the invention relate to a computer program product (non-transitory computer readable storage medium having instructions, which when executed by a processor, perform actions) with program code stored on a machine-readable medium, for carrying out the method according to embodiments of the invention or one or more preferred variants of the method according to embodiments of the invention, when the program code is executed on a computer.

Moreover, embodiments of the invention comprise a computer program with program code for carrying out the method according to embodiments of the invention or one or more preferred variants of the method according to embodiments of the invention, when the program code is executed on a computer.

### BRIEF DESCRIPTION

Some of the embodiments will be described in detail, with reference to the following FIGURES, wherein like designations denote like members, wherein:

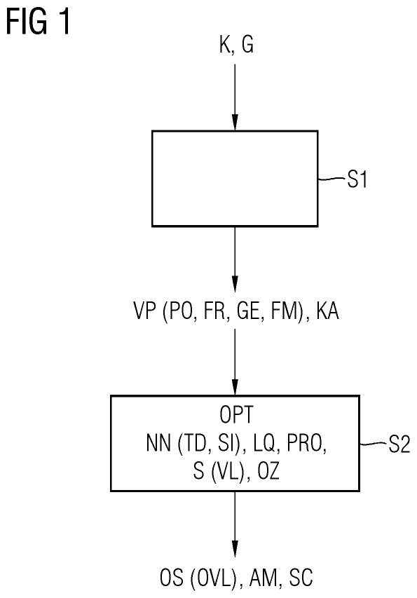

FIG. 1 shows a flowchart which visualizes the method steps carried out in one variant of the invention.

### DETAILED DESCRIPTION

Starting point of the embodiment of the method according to embodiments of the invention described here is a predetermined area G, which could be a city or a district, for example. A multiplicity of motor vehicles are traveling in this area, said motor vehicles being denoted in general with reference sign K in FIG. 1. Now, the goal is to obtain an optimized traffic control of the motor vehicles K, taking into account air quality values in the considered area G. To this end, the method described below is used, in which traffic control actions, which have been optimized using a computer, are ascertained. The computer is integrated in a traffic control center. The ascertained optimized traffic control actions are transmitted to suitable variable traffic signaling devices by the traffic control center, on the basis of which the motor vehicles are then steered in such a way that there is traffic control taking account of the best possible air quality.

According to step S1 of the method in FIG. 1, values of traffic parameters VP in the predetermined area G are ascertained by way of data capture. At least some of the vehicle parameters are related to the motor vehicles K traveling in the predetermined area in this case. The traffic parameters of a respective motor vehicle comprise its current position PO, it's direction of travel FR, its speed GE and also the vehicle model FM of the motor vehicle, i.e., the precise make and the precise vehicle type of this make. In the embodiment described here, the position PO, the direction of travel FR and the speed GE are ascertained by way of cameras KA, which are installed on the streets of the predetermined area.

Where necessary, the vehicle model FM of the motor vehicle can also be derived directly from the sensor data of the cameras by way of suitable object recognition. However, the vehicle model is determined indirectly by way of license plate recognition in a preferred variant. Here, the license plates of the corresponding motor vehicles are extracted from the images captured by the cameras by way of object recognition. The corresponding vehicle model can then be read by way of the license plate from a comparison with a database, which contains the vehicle model for every licensed motor vehicle. Since the pollutant emissions of a motor vehicle depend on the vehicle model, these traffic parameters reflect the pollutant emissions well.

The traffic parameters VP determined in step S1 at a certain time are used for an optimization OPT in a subsequent step S2. This optimization uses a data-driven model in the form of a learned neural network NN. This neural network is learned on the basis of training data TD, which in turn are obtained from a simulation SI. Here, a simulation known per se is used as a simulation, for example the simulation described in document [1].

The neural network NN is configured to simulate air quality values LQ for a multiplicity of points in the entire considered area G on the basis of current or predicted values of the traffic parameters VP. In the embodiment described here, the air quality values are represented by pollutant concentrations of nitric oxides and/or particulate matter. In this case, the air quality reduces with increasing air quality value. However, the air quality value can also be defined differently and, for example, represent the inverse of the specified concentrations. In that case, higher air quality values represent better air quality in the considered area G.

Since the simulation SI is time-consuming, it is not carried out directly in the method of FIG. 1 since the results of this method must be determined substantially in real time. Instead, the simulation SI is used in advance for generating the training data TD, by which the neural network NN is then likewise learned in advance. Expressed differently, the simulation SI is carried out in advance for a multiplicity of different values of traffic parameters and in each case outputs air quality values in the process. The values of the traffic parameters with the output air quality values represent a suitable training data set. In the process, a multiplicity of training data sets is generated, which are subsequently used in a manner known per se for learning the neural network NN.

In the method of FIG. 1, the corresponding air quality values LQ in the considered area G are obtained from predicted values of traffic parameters VP by the learned neural network NN. Here, the predicted values of the traffic parameters originate from a prediction PRO, according to which values of the traffic parameters VP are respectively predicted proceeding from the current values of the traffic parameters, ascertained in step S1, for many different sets S of traffic control actions VL, which comprise the adjustment of variable traffic signaling devices. Corresponding prediction methods are known to a person skilled in the art and are therefore not explained in detail. In the exemplary embodiment described here, the sets S of traffic control actions VL also comprise a set of so-called null actions, i.e., no traffic control actions are carried out, and so the predicted values of the traffic parameters correspond to the values at the current time obtained in step S1. Then, air quality values LQ that are predicted by the neural network NN are ascertained, and are predicted in this sense, for the multiplicity of points in the entire area G from the predicted values of the traffic parameters, which belong to different sets of traffic partial actions.

Subsequently, the optimized set OS of optimized traffic control actions OVL that comes closest to the optimization goals is ascertained from the sets S of traffic control actions VL by optimization goals OZ. In the embodiment described here, the optimization goals comprise, firstly, the goal of the highest possible overall air quality in the entire area G and the goal of the lowest possible variation of the air quality values in the entire area. These goals can be taken into account by way of a suitably defined cost function. The individual goals are included in the cost function with appropriate weights, wherein, depending on the configuration, the weights can be chosen differently depending on the prioritization of the goals.

In the embodiment described here, the traffic control actions VL and hence also the optimized traffic control actions OVL comprise the adjustment of variable signaling devices, which are in the form of traffic lights AM and road signs SC with variable content. By way of example, detours can be brought about by way of these road signs. Likewise, the legal speed limit can be adapted by adapting the content of a corresponding road sign.

Finally, the optimized set OS of traffic control actions OVL is carried out, triggered by commands in the traffic control center; i.e., the variable traffic signaling devices are adapted according to the optimized traffic control actions OVL. Sometimes, the case may be that the aforementioned null actions are ascertained as optimized set of traffic control actions according to the optimization. In this case, there is no change in the existing variable traffic signaling devices.

In an optional configuration of the above-described method, the traffic control actions may also comprise actions that relate to the local public transport system in the considered area, for example an adaptation of the frequency of lines in the local public transport system or an adaptation of the capacity of transportation or transportation means in the local public transport system. Moreover, the above-described values of the traffic parameters may also comprise further values, e.g. real pollutant measurements in the considered area.

Likewise, the values of the traffic parameters need not necessarily be captured by a camera. Rather, the individual motor vehicles may also transfer the corresponding traffic parameters to receivers at the edge of the road, the latter subsequently transmitting received values to the traffic control center. Moreover, the traffic control actions may also comprise diversion instructions where applicable, which are transferred to certain motor vehicles by way of appropriate transmitters at the edge of the road so that a route in these motor vehicles is altered accordingly and the driver then travels a different route.

Moreover, the above-described goals of optimization may also comprise other or further optimization goals. By way of example, one optimization goal may consist in only intending to reach the highest possible air quality for certain regions in the predetermined area. Moreover, a neural network need not necessarily be used as learned data-driven model. Instead, other data-driven models, such as support vector machines, for example, can likewise be used. All that is decisive is that the data-driven models can be learned in a suitable manner by way of machine learning methods on the basis of the above-described training data.

The embodiment of the invention described above has a number of advantages. In particular, a method for intelligent traffic control is created, which takes account of the air quality during real-time decision making for setting traffic control actions. In the process, use is made of a machine learned data-driven model, the training data of which originate from simulations. The real-time capability of the method is ensured by the use of the data-driven model. The prediction of air quality values obtained by way of the data-driven model allows the determination of suitable traffic control actions while taking account of a sufficient air quality.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A method for computer-implemented traffic control of motor vehicles in a predetermined area, wherein, at predetermined intervals, respectively:
values of traffic parameters are ascertained in the predetermined area by way of data capture, wherein at least some of the traffic parameters relate to the motor vehicles traveling in the predetermined area and the traffic parameters of a respective motor vehicle include its current position, direction of travel and speed;
a set of optimized traffic control actions, which comprise the adjustment of variable traffic signaling devices, is determined by an optimization using a learned data-driven model and the optimized traffic control actions are carried out;
wherein the learned data-driven model is configured to ascertain output quantities in the form of air quality values for a multiplicity of points in the predetermined area from input quantities in the form of values of the traffic parameters and wherein the data-driven model is learned from a simulation by training data sets, wherein a respective training data set have values of the traffic parameters and associated air quality values that are determined by way of the simulation;
wherein the optimization includes a prediction of air quality values, according to which values of the traffic parameters are respectively predicted proceeding from the ascertained values of the traffic parameters for different sets of traffic control actions, from which predicted values of the traffic parameters predicted air quality values for the multiplicity of points are ascertained by the learned data-driven model, and wherein the set of optimized traffic control actions is determined by the optimization from the different sets of traffic control actions on the basis of a number of optimization goals, which include at least one of the goal of the highest possible overall air quality taking account of all predicted air quality values for the multiplicity of points; and the goal of the highest possible partial air quality taking account of some of the predicted air quality values for some of the multiplicity of points.

2. The method as claimed in claim 1, wherein the data-driven model is a neural network structure made of one or more neural networks.

3. The method as claimed in claim 1, wherein the number of optimization goals further comprises the goal of the lowest possible variation of the predicted air quality values over the predetermined area.

4. The method as claimed in claim 1, wherein the traffic parameters further contain at least one of the vehicle model of the respective motor vehicles and air quality measurements at a number of measurement points in the predetermined area.

5. The method as claimed in claim 1, wherein the data capture comprises the capture of at least one of position, speed, direction of travel and the license plate of the respective motor vehicles using a multiplicity of cameras.

6. The method as claimed in claim 1, wherein the data capture is configured in such a way that at least some of the traffic parameters are wirelessly transmitted by the motor vehicles and received by a multiplicity of receivers in the predetermined area.

7. The method as claimed in claim 1, wherein the variable traffic signaling devices comprise at least one of traffic lights and road signs with a variable information content.

8. The method as claimed in claim 1, wherein the optimized traffic control actions comprise actions that influence the local public transport system.

9. The method as claimed in claim 1, wherein the optimized traffic control actions comprise diversion instructions, which are transmitted to at least some of the motor vehicles and which adapt the route of the navigation system in the corresponding motor vehicle.

10. The method as claimed in claim 1, wherein the optimized traffic control actions cause one or more road sections in the predetermined area to be shut for at least some of the motor vehicles.

11. The method as claimed in claim 1, wherein the simulation is continued on the basis of traffic parameters that are ascertained using the data capture during the method, as a result of which new training data sets are obtained, by which the learning of the data-driven model is continued during the method.

12. An apparatus for computer-implemented traffic control of motor vehicles in a predetermined area, wherein the apparatus is configured to carry out a method in which, at predetermined intervals, respectively:
values of traffic parameters are ascertained in the predetermined area by way of data capture, wherein at least some of the traffic parameters relate to the motor vehicles traveling in the predetermined area and the traffic parameters of a respective motor vehicle include its current position, direction of travel and speed;
a set of optimized traffic control actions, which have the adjustment of variable traffic signaling devices, is determined by an optimization using a learned data-driven model and the optimized traffic control actions are carried out;
wherein the learned data-driven model is configured to ascertain output quantities in the form of air quality values for a multiplicity of points in the predetermined area from input quantities in the form of values of the traffic parameters and wherein the data-driven model is learned from a simulation by training data sets, wherein a respective training data set includes values of the traffic parameters and associated air quality values that are determined by way of the simulation;
wherein the optimization includes a prediction of air quality values, according to which values of the traffic parameters are respectively predicted proceeding from the ascertained values of the traffic parameters for different sets of traffic control actions, from which predicted values of the traffic parameters predicted air quality values for the multiplicity of points are ascertained by the learned data-driven model, and wherein the set of optimized traffic control actions is determined by the optimization from the different sets of traffic control actions on the basis of a number of optimization goals, which include the goal of the highest possible overall air quality taking account of all predicted air quality values for the multiplicity of points and/or the goal of the highest possible partial air quality taking account of some of the predicted air quality values for some of the multiplicity of points.

13. The apparatus as claimed in claim 12, wherein the apparatus is configured to carry out a method.

14. A computer program product, comprising a computer readable hardware storage device having computer readable program code stored therein, said program code executable by a processor of a computer system to implement a method with program code stored on a machine-readable medium, for carrying out the method as claimed in claim 1 when the program code is executed on a computer.

15. A computer program with program code for carrying out the method as claimed in claim 1 when the program code is executed on a computer.

16. The method as claimed in claim 8, wherein the optimized traffic control actions comprise at least one of a change in the frequency of one or more lines of the local public transport system and a change in the capacity of transportation in the local public transport system.

17. The method as claimed in claim 10, wherein the optimized traffic control actions cause one or more road sections in the predetermined area to be shut for motor vehicles with a certain type of engine.
